(19) United States
(12) Patent Application Publication
(10) Pub. No.: US 2014/0298963 A1
(43) Pub. Date: Oct. 9, 2014

(54) CIRCULAR SAW BLADE ASSEMBLIES

(71) Applicant: THOMAS J. RUZICH, BAKER CITY, OR (US)

(72) Inventor: THOMAS J. RUZICH, BAKER CITY, OR (US)

(21) Appl. No.: 13/858,741

(22) Filed: Apr. 8, 2013

(51) Int. Cl. B23D 61/02; B23D 61/06

(52) U.S. Cl. CPC B23D 61/025; B23D 61/06
USPC 83/13; 83/698.41; 83/830

(57) ABSTRACT

What is disclosed is a circular core for a rotary or circular saw typically used in rescue type operations for cutting openings in building material and featuring alternating pockets on the circumference of the core for the placement of drive links of a chain having cutting segments such that the pockets alternate between pockets on each side of the circular core.

### TECHNICAL FIELD

This invention relates to circular saw blade assemblies, and more particularly to improve circular saw blade assemblies for cutting various hard materials such as building materials, and utilizing a chain with cutting portions positioned on the blade core such that a cutting tip section can be replaced by replacing the chain or sections of the chain.

### BACKGROUND

Generally in the field of circular cutting saws, blades, and blade assemblies, the tooling utilizes a circular blade core, the circumference of which is configured with a cutting section. Generally, the circumference has individual cutting elements attached to the blade, specifically to the blade core. These blade cores, when used with a rotary saw, spin at very high speeds cutting material in the path of the blade. The cutting elements have relatively high deterioration rates due to abrasion and impacts from the cutting. This abrasion is caused by wear due to the grinding and cutting process that leads to a large amount of frictional heat generated as well as abrasive contact with the saw blades.

In general, circular saw blade assemblies are made in two different embodiments. In a first general embodiment, the circular saw blade assemblies comprise a core having cutting segments affixed to the core, typically by welding, soldering, braising, electroplating, or bolting the cutting element to the core. Alternatively, as shown in U.S. Pat. No. 4,627,322, the contents of which are hereby incorporated by reference, it has been contemplated to use replaceable chains, such as cutters attached to removable chains such as chains found on a chainsaw, on the exterior of the core to form the cutting element. In this embodiment it is thought that in the event that the cutting tips of the saw become dull or damaged, the chain can be removed and the chain links containing the cutting tips can be replaced or new cutting tips placed on the chain. While the chain is being repaired, a second chain can be used in the meantime on the original core, thus avoiding the need for a new blade core to be used each time the cutting elements must be replaced or repaired (such as when the tips must be sharpened).

The difficulty in using these cutting chain and/or blade assemblies is that a method or device has not been developed that leads to proper function of the chain and blade assembly when rotating at the high speeds needed for cutting. As illustrated in WO Patent Publication No. 2011/089610, the drive links 130 of the publication with gullies and sprocket teeth around the circumference of the blade core. FIGS. 10a and 10b depict the alternating gullies and sprocket teeth around the circumference of the blade core. When the blade core spins at a very high rate, the chain extends out from the spinning blade due to centrifugal force, thus driving the chain drive links away from the blade core. Placing each chain length around the circumference of the blade core using alternating sprocket teeth and gullies is thought to be unstable and potentially not safe to the operator or any third party in the area of the saw user as the potential for the chain to come off of the blade core from chain stretch due to heat expansion and lengthening of the chain caused by cutting impacts flattening the rivets that hold the chain together.

### SUMMARY OF THE DISCLOSURE

Accordingly, what has been developed is a blade core having pockets for chain drive links found on alternating edges of the core.

For the purposes of this application, the term drive link means the general shape of a standard drive link of a chain as depicted, for example, in FIG. 1, reference number 14, and FIGS. 4, reference number 58, and FIG. 5, reference number 70.

The terms “circular saw” and “rotary saw” are used herein interchangeably.

What is disclosed is a circular saw assembly. One embodiment, a circular core for a saw blade is disclosed. A circular core is for use of a chain, specifically a chain configured to be in an endless loop. The circular core in this embodiment is a circular disc like core body having an outer circumference and a width. The core body has a central arbor located at or near the center of the disc and is configured to provide an axis for rotation for a circular saw. The circular disc has a first side and a second side that is separated by width. There is a series of pockets on the outer circumference of the core. The pockets start at either the surface of the first edge or the second edge and protrude inward on the width of the core. The pockets do not span the width of the circular core. The pockets project inward from the circumference of the circular disc like core toward the central arbor. The pockets are spaced to fit a series of drive links of the center of the chain. The pockets alternate along the circumference of the core such that the successive drive links of a chain are placed onto the core from alternating sides of the core. In a preferred embodiment, these pockets are shaped to be in the drive link of a chain. This is generally, in a preferred embodiment, a drive link and corresponding shaped pocket.

In a preferred embodiment, the core features an endless chain that is an endless loop. The chain can be attached to the core by removing a rivet of the chain and subsequently wrapping a chain around the core with the drive links positioned in the alternating pockets and subsequently replacing the rivet in the chain. Preferably, the chain is fairly taut on the circular disc like core such that when the core spins at a extremely high rate of speed, for example 5,400 rpms, the chain does not come off of the core and instead when the chain and core impact a material to be cut, the material is cut. In a preferred embodiment, this chain core assembly is used in fire rescue and similar rescue to cut, for example, openings in building to allow for ingress or egress, for air ventilation, and cuts in various building materials searching for victims of building collapse from natural disasters or terrorist attacks. In a preferred embodiment, the chain used on the circular core is Bullet® Chain, this Bullet® Chain is chain that is manufactured by Edge Industries Inc. in Baker City, Oreg. This chain is generally described in U.S. Pat. No. 5,056,395, the contents of which are herein incorporated by reference, and the type of cutting tip referenced in the patent is herein referred to as a “Bullet® Chain”.

In a preferred embodiment, this chain features sections that are configured to be cutters. This means the cutters have a cutting surface such as found in the Bullet® Chain. While the tolerance of the gap between the chain, drive link and the pocket can vary, it is thought that the closer and thus lower distance between the two is preferred. Thus, a variety of tolerances can be used as long as the chain is operational and not coming off of the core. The core disclosed is typically used in applications in which the chain and core are spinning at extremely high rates of speed as needed for cutting in the rescue industry. In a preferred embodiment of the invention, the core can be sold with or without a chain. The core design allows for interchangeability of chains on the core. This allows for the repair or replacement of the chains or segment of the chains. It is thought that in a preferred embodiment, the chains are used in conjunction with a circular saw. For example the circular saw that is considered to be an ideal saw with the invention is thought to be the rotary rescue saw, model number CE760, CE970, and/or CE1260 manufactured by Edge Industries Inc.. This saw is ideally used with the carbide tipped Bullet® Chain also manufactured by Edge Industries Inc., although a wide variety of rescue saws and/or chains, and/or cutting edges are available.

In a preferred embodiment, the disclosure of the application features a method of using a circular core and chain in order to cut in material. The method includes attaching a chain to a circular core, attaching the circular core to a rotary or circular saw and subsequently using the cutting assembly to cut the material.

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 illustrates the left side isometric view of a circular saw blade having cutting elements with drive link pockets on alternating sides of the blade core.

FIG. 2 illustrates a first side view of the blade core and chain having alternating drive link pockets in the shape of the chain drive link.

FIG. 3 illustrates a second side view of the blade core, in which the blade core has drive link pockets on alternating sides.

FIG. 4 is a right side view of the chain and blade core apparatus.

FIG. 5 is the left side view of the chain and blade core apparatus.

FIG. 6 is a perspective view of the chain and blade core apparatus illustrating the mechanism of the attachment of the chain to the blade core.

FIG. 7 is a front view of the blade core without a chain attached.

FIG. 8 is a left perspective view of the blade core without a chain attached.

FIG. 9 is a right perspective view of the blade core without a chain attached.

FIG. 10 is a left side view of a blade core without a chain attached.

FIG. 11 is the right side view of the blade core without the chain attached.

FIG. 12 is a left perspective view of the blade core featuring chain drive link pockets in the shape of the drive link of the chain.

FIG. 13 illustrates a left side view of the blade core featuring chain, in which the blade core has chain drive link pockets.

FIG. 14 illustrates a left side view of the blade core having drive link pockets in the shape of a chain drive link.

FIG. 15 illustrates a second left side view of a blade core having chain drive link pockets in the shape of a drive link of a chain.

### DETAILED DESCRIPTION OF THE EXEMPLARY EMBODIMENTS

In the following description and in the figures, like elements are identified with like reference numerals.

The use of “e.g.,” “etc.,” and “or” indicates non-exclusive alternatives without limitation unless otherwise noted.

The use of “including” means “including, but not limited to,” unless otherwise noted.

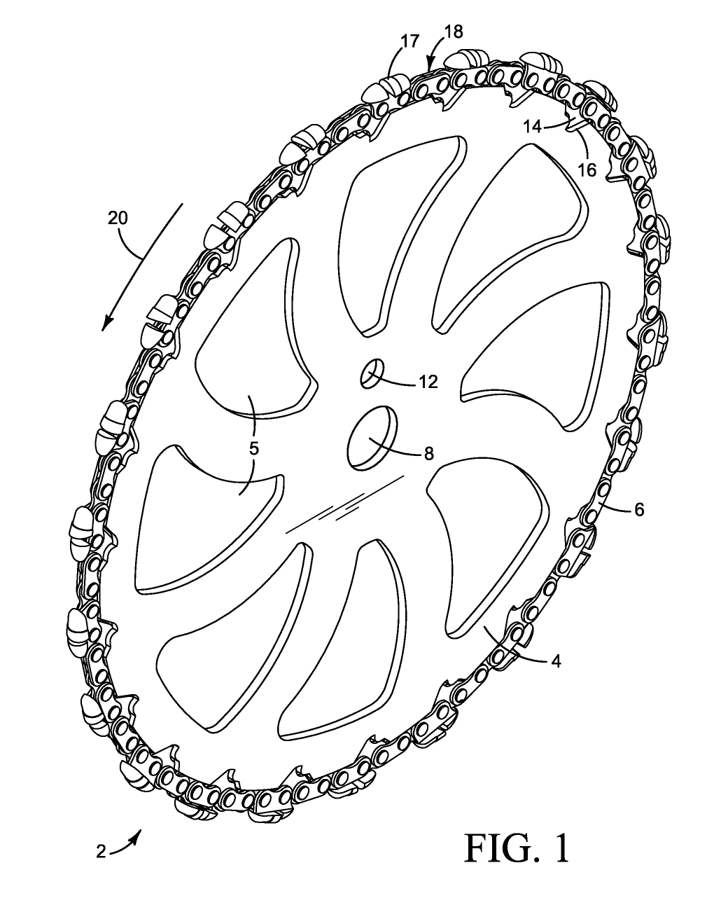

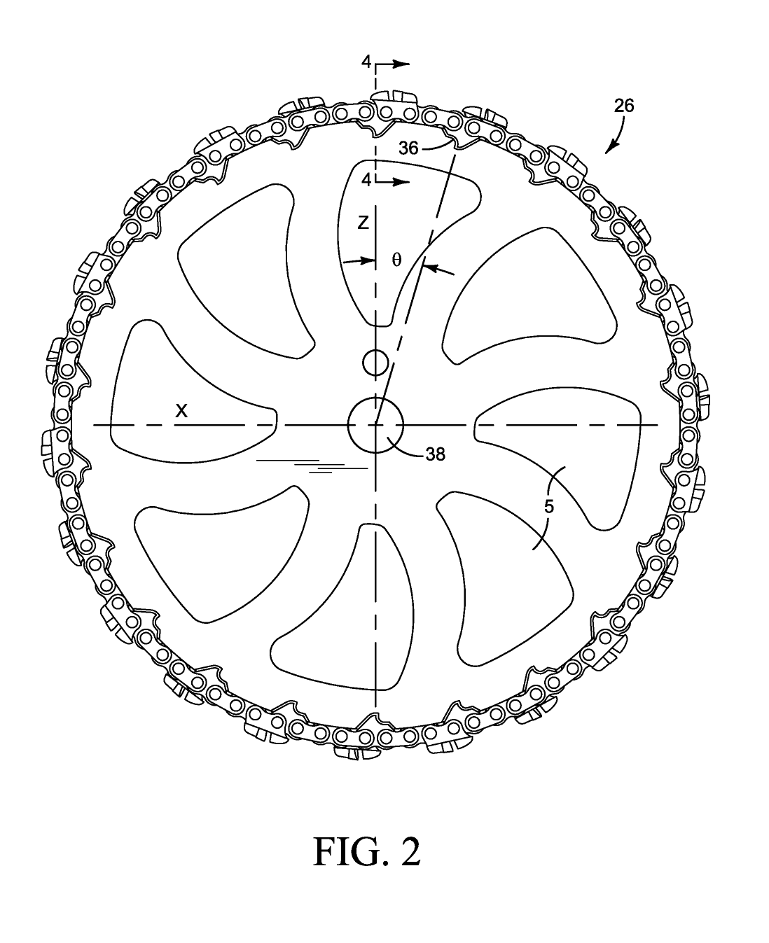

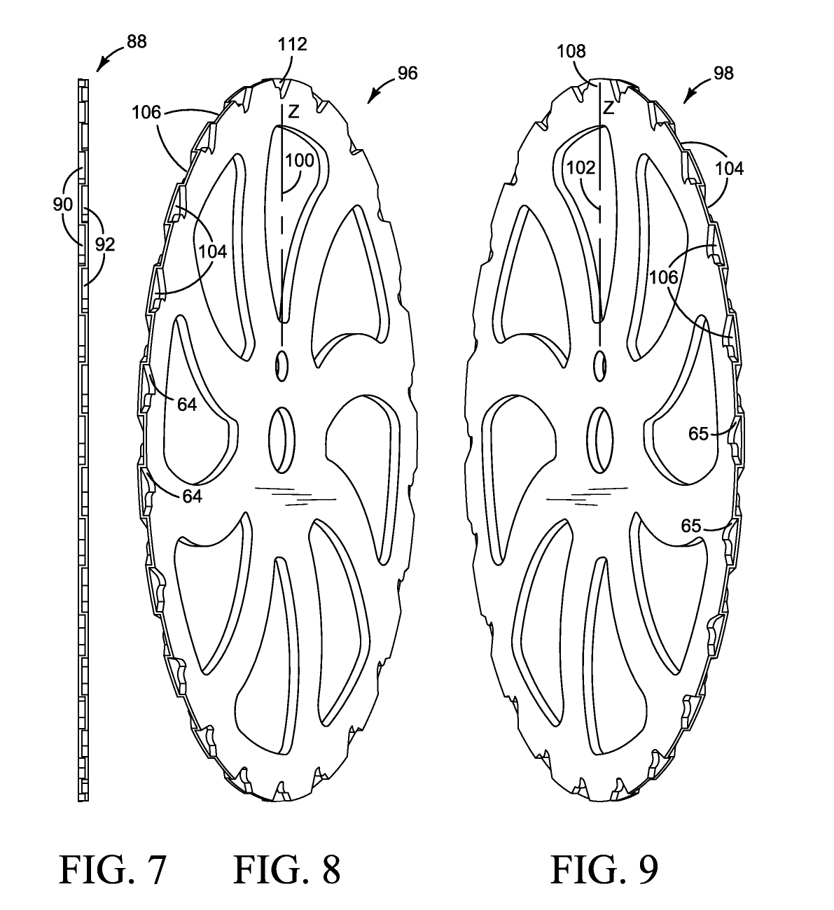

FIG. 1 illustrates a left side isometric view of the blade of the current invention with a chain attached. The blade and chain combination 2 have a core 4 that has chain 6 attached to the core. The core has a pocket that runs around the outer circumference of the blade 4 into which the chain drive links 14 fit. The pocket 16 for the drive links 14 are positioned such that the pockets are on alternating sides of the core for successive drive links. This is illustrated further in the later figures, specifically, for example, FIGS. 2, 3, 4 and 5. Opening 8 is an arbor hole for attaching the blade core to a saw while hole 12 is a locating hole used in manufacturing of the core. Openings 5 can be manufactured into the core for, amongst other things, weight reduction purposes. The blade core is manufactured in the preferred embodiment with holes 5 for attachment to rotary saw. This is so the saw blade can be used most ideally in rescue saws, although virtually any rotary saw is contemplated by the invention. The circular saw blade when attached to a circular rotary saw rotates in direction 20 when the blade is spinning. This allows the drive links 14 to be pushed by the saw blade 16. It is thought that the shape of the pockets for the drive links 14 in a variety of shapes, although it is currently thought that the most efficient is to closely model the shape of the drive link 14, as illustrated in FIG. 1. As illustrated in FIG. 1, chain 6 comprises cutting element 17 which has the cutter along with drive link 14 and tie strap 18. It is thought that the embodiments of the current invention will work in an improved manner if manufactured and used without the sprocket teeth described in WO 2011/089610 (expressly illustrated in FIG. 7b as reference number 216 as well as in FIG. 8 and FIG. 9). It is further thought that if the pockets are manufactured in a general V-shape (or a V-shape but with slanted edges as in a V but with a rounded tip such as in a U-Shape) such that the pocket maintains contact with the leading edge and the heel of the drive link and without placing pressure at the narrow tip at the bottom of the drive link that the pockets will lead to increased durability by lessening the friction and/or pressure placed on the tip of the drive link, and thus leading to a longer function life of each chain drive link.

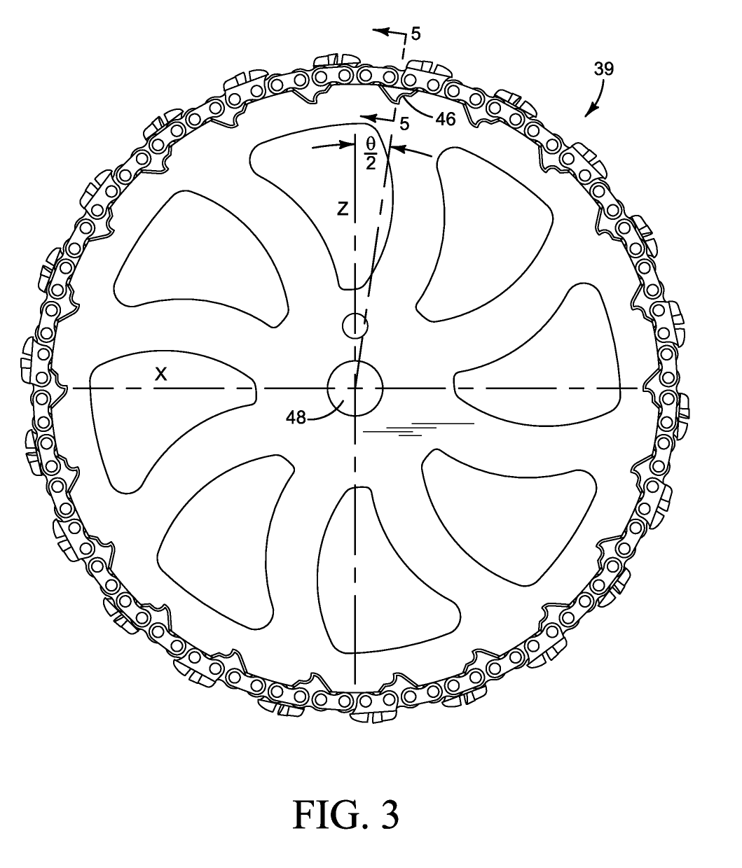

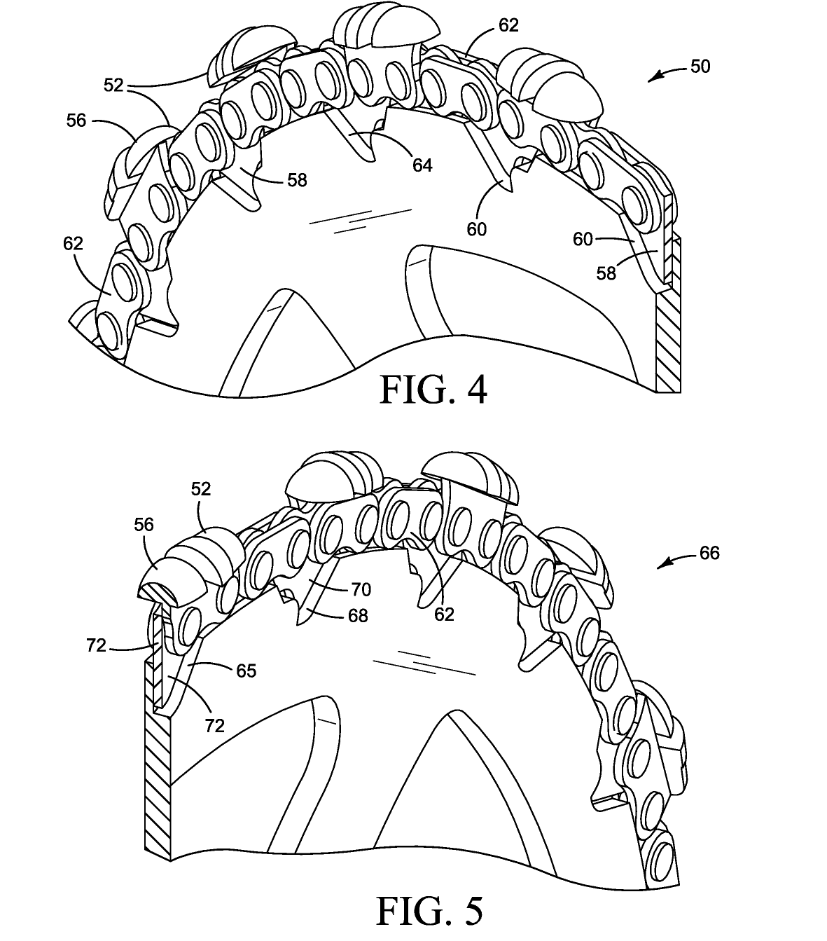

FIGS. 2 and 3 illustrate the staggered (or alternating) arrangement of pockets into which the drive links fit. FIGS. 2 and 3 illustrate that on each side of the core the drive link pockets 46, 36 are staggered such that consecutive drive links are placed onto the blade from opposing sides. It is thought, that in contrast to previous circular cores or blades, this allows the chain to be held onto the blade with significantly more control. This prevents the chain from wallowing to one side or the other if gullies and sprocket teeth around the circumference of the blade. Angle Θ, and Θ/2, 34, and 40 respectively, illustrate that the angle between the lines illustrated between axis holes 38, 48 and pocket 36, 46 illustrate the differing angles of Θ and Θ/2 are different in relation to one another from each side. As illustrated, the angle in FIG. 3 is half as large as in FIG. 2 illustrating the staggering of pockets in relation to the drive link of the chain. This illustrates that from the axis Z and X, the pockets on opposing sides of the core are alternating. It is noted that the terms left side and right side are chosen and are interchangeable names that are merely used to name each side of the core. Alternatively, for example, the terms top and bottom or first side and second side could be used. As illustrated in FIG. 2, FIG. 4 represents a cross section of section line 4. FIG. 5 illustrates cross sectional view along line 5 of FIG. 3. FIG. 4 illustrates the depth and organization of the core in relation to the chain. In FIG. 4, the chain comprises cutters 52, and depth gages 56 as found in a standard chain. The cutting links are connected via tie straps 62. In between each link is a drive link 58 that is found within pockets 60, 64. The overall chain and core, 50, are viewed from the right side in FIG. 4. FIG. 5 represents a view of the opposite side 66 of the same core. As illustrated, drive link 70, 72 fit within pockets 68, 65. The overall grove 68, 60 in FIGS. 4 and 5 are alternating such that the continuous drive links are placed in alternating pockets found on the blade core. It is currently thought that the ideal measurements of the pocket are 1.5 inches apart from centerline to centerline of each alternating pocket on the same side of the blade core.

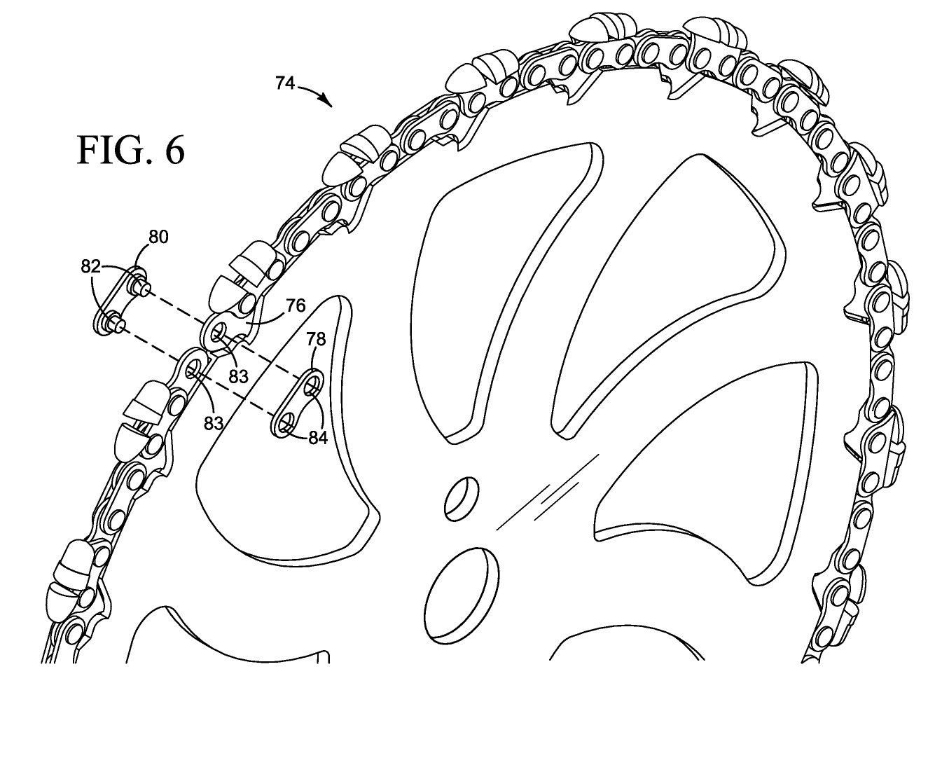

FIG. 6 illustrates the mechanism of attaching the chain to the core of the blade. The chain mechanism has a joining link or a plurality of joining links, that have a tie strap, 80, that has two prongs 82, that fits through openings 83 and into openings 84 of connector piece 78. These are then pressed into place using a riveting tool. It is thought that the removability of the chain this way is what is a distinct advantage over the prior art, in addition to the alternating pockets found upon the blade core.

FIG. 7 illustrates an end or front view of the blade core 88. This illustrates that the outer circumference of the blade core has the alternating pockets 92, 90 for the drive link of the chain. This is further illustrated in FIGS. 8 and 9 which illustrate the first side perspective and the second side perspective and altering Z axis line 100, 102 illustrating the staggered pockets of the blade core. In the first side perspective of FIG. 8, the drive link fits into 112, 106, and 104. Drive links 106,104 are alternating such that the consecutive drive links fit into alternating pockets. The first side perspective view 96 is opposite of right side perspective view 98 of FIG. 9. FIG. 9 illustrates the opposite side of the alternating pockets 104,106. FIGS. 8 and 9 illustrate the varying point of alternating pockets 112,108 along axis Z.

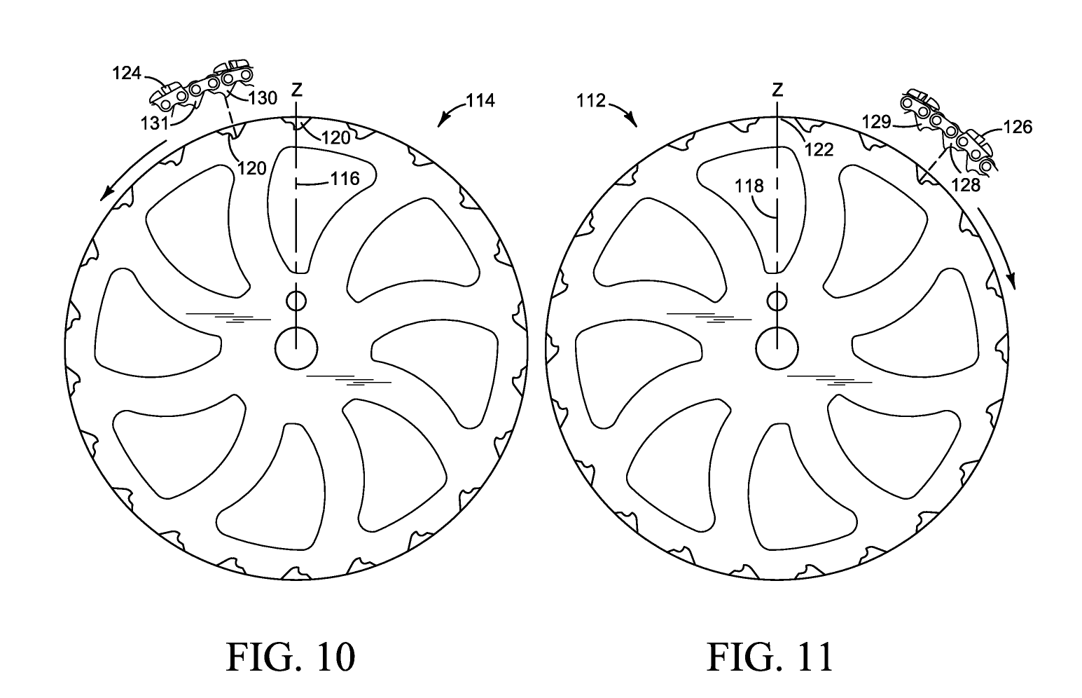

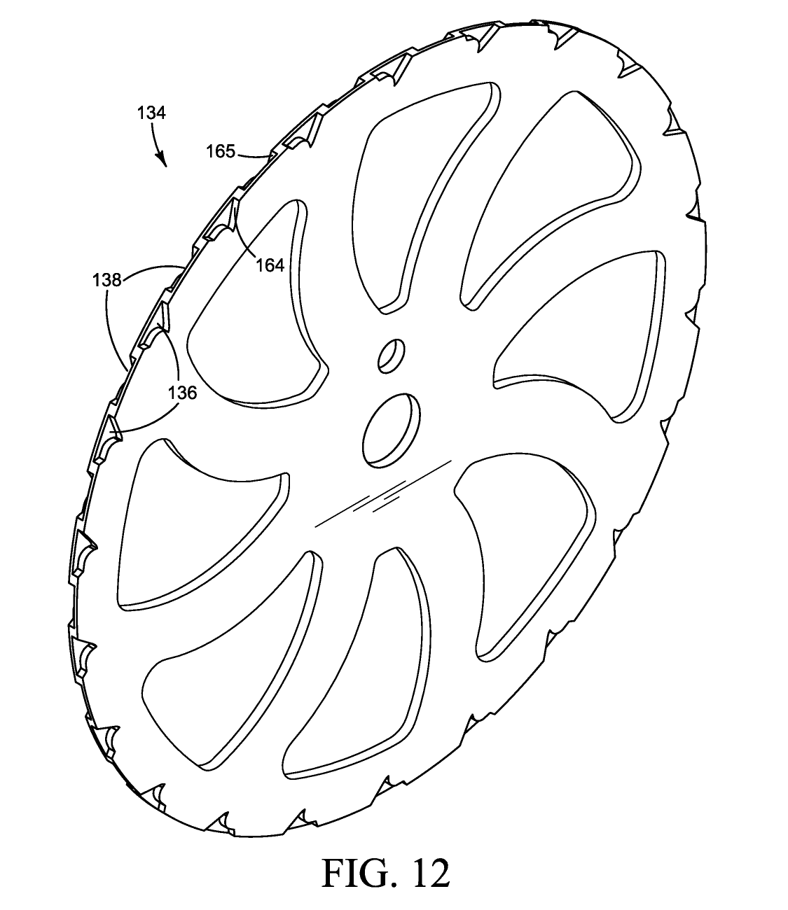

FIGS. 10 and 11 illustrate the location in which the drive links fit into pockets. As illustrated, FIGS. 10, and 11 are opposing first and second side views of a blade core 113, 114. Again, axis Z, 116 and 118 of FIGS. 10 and 11, is oriented with pocket 120 on the first side of the blade core and illustrates that on the opposing side of axis Z there is no pocket for the drive link, 122, instead these pockets are alternating. FIG. 10 illustrates how drive link 130 of chain 124 fits into pocket on the first side of the blade core whereas, on second side of blade core drive 128 of opposing view 126 of the chain 124 of FIG. 10 fits into the pocket 128. Conversely, the drive links 129, 131 fit into pockets not shown on FIGS. 10 and 11 which would show up on the opposing side. For example, 131 which would be placed in a not illustrated pocket in FIG. 10 but in a pocket illustrated FIG. 11. The converse is true for drive link 129 as being positioned within a pocket in FIG. 10, as opposed to a pocket on FIG. 11. This illustrates the alternating mechanism of the pockets on the drive core. FIGS. 12 through 15 illustrate what is thought to be a preferred embodiment of the invention in which the alternating pockets 138, 136 are oriented on blade core 134 so as to have the shape of the drive link of the chain. It is thought that this will prevent excess wobble of the chain when the blade core 12 is rotated at high speed, particularly in a cutting situation. FIG. 12 illustrates alternating pockets 164, 165 located on the circumference of blade core 134

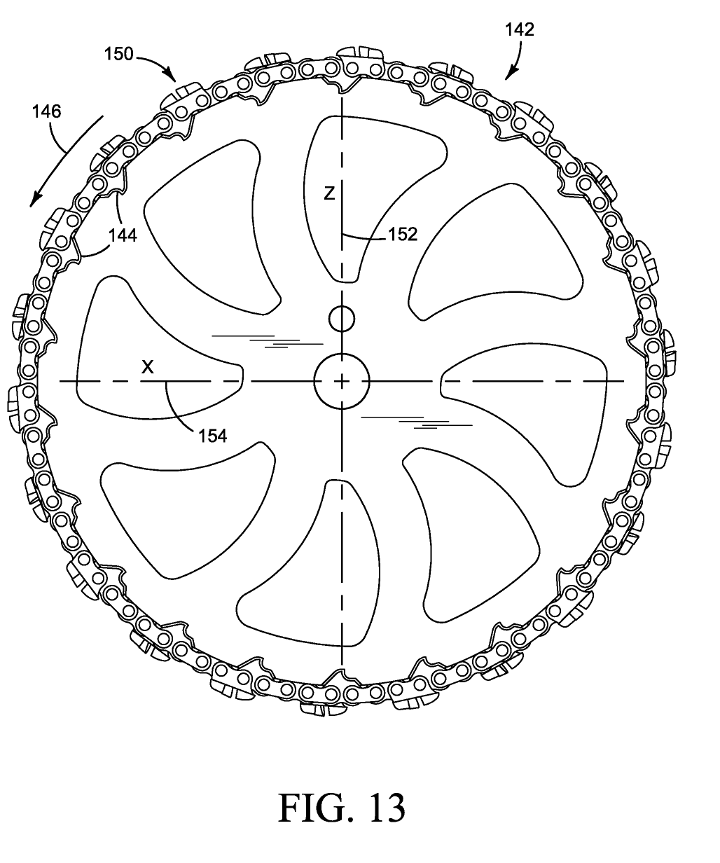

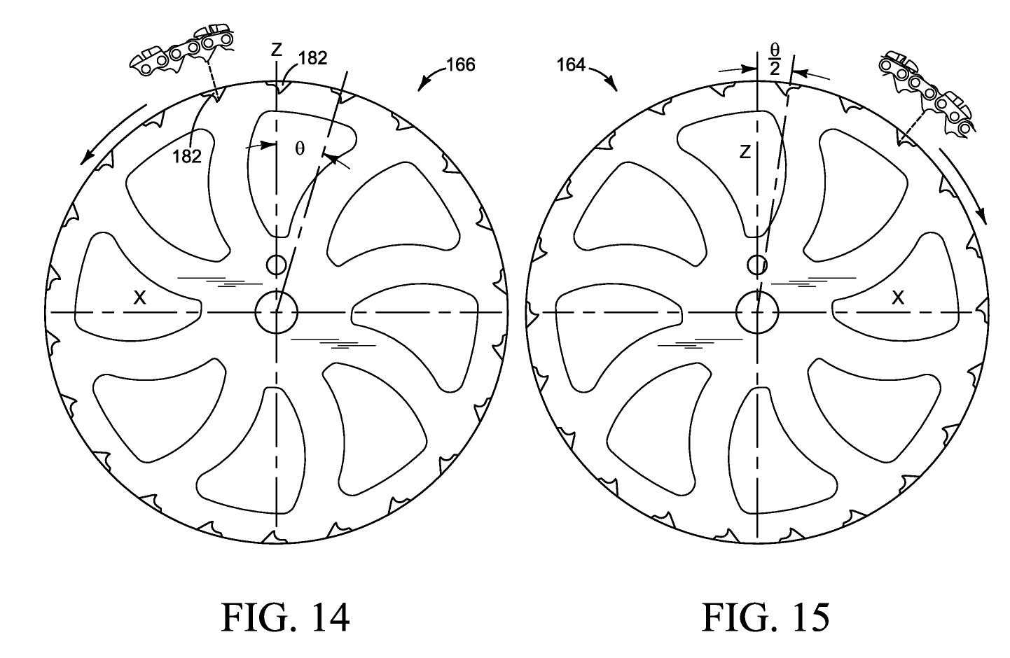

FIG. 13 illustrates drive link 134 inserted within pockets on the core 142. The core and chain arrangement 142 rotates in direction 146 for cutting. The cutting mechanism has a raker gauge that sets the depth of cut or amount of material for cutting, in this case 0.013″, which is a part of cutter 150. Pockets 144 are located in an alternating manner from pockets (not shown) positioned on the opposite side of the circular core. As illustrated, axis X 154 illustrates where on the reverse side of the core, pockets for the continuous drive chain links would be found. The same for axis Z, 152 illustrates where on the shown side the drive links are placed with the groups. FIGS. 14 and 15 illustrate the first side of the preferred embodiment of the drawing of FIG. 14 and the second side of the preferred embodiment of FIG. 15. As illustrated on the first side, pocket 182 is placed along axis Z such that angles on axis Z, line 176, and the first chain drive link pocket on the first group on axis Z is angle Θ. Whereas in FIG. 15, angle Θ between axis Z 170, 180 and the first drive link pocket from axis Z is on line 168, with the angle being Θ/2, 172.

While certain exemplary embodiments are shown in the Figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A circular core for a saw blade for use with a chain, said circular core comprising:
a circular disc like core body having an outer circumference and a width, wherein said core body comprises a central arbor substantially at the center of said core body and configured to provide an axis of rotation for a circular saw,
wherein said core body comprises a first side and a second side separated by said width of said core body, wherein said first side and said second side comprise a plurality of pockets projecting inward from said circumference toward said central arbor, wherein said pockets are spaced to fit a series of drive links of a saw chain, wherein said pockets comprise indentations that do not span the full width of said arbor, wherein said groves comprise alternating pockets such that said circumferences comprises alternating pockets on said first side and said second side.

2. The circular core for a saw blade for use with a chain of claim 1, said circular core comprising a chain attached to said circumference of the circular core in the pockets, wherein said chain comprises an endless loop, wherein said endless loop comprises drive links positioned within said alternating pockets of said circular core and operatively positioned such that when said circular core rotates said chain rotates with said circular core.

3. The circular core of claim 2, wherein said circular core is attached to a Bullet® Chain.

4. The circular core of claim 2, wherein said chain comprises pairs of interconnected segments carrying links and driving links, wherein said chain driving links comprise two carrying links interconnected by a drive link, wherein at least one of said carrying links comprises a cutting surface.

5. The circular core of claim 1 wherein said pockets are in the shape of a drive link of a chain.

6. The circular core of claim 2 wherein said pockets are in the shape of said drive links of said chain.

7. The circular core of claim 6 wherein said pockets and said drive links are configured to be in close proximity when said circular core is attached to a chain.

8. A circular saw blade assembly for use in a circular saw, wherein said circular saw blade assembly comprises:
a circular core, said core comprising a circumference, a first side, a second side, and a thickness separating said first side and said second side, wherein said circumference comprises pockets extending inward from one of said first side or said second side and wherein said pockets do not span the thickness of said core, wherein said pockets are spaced such that a series of drive links of a chain comprising an endless loop are configured to be positioned in said pockets, wherein each of said pockets in said series of pockets alternates with consecutive pockets in said series in extending either inward from said first side of said circular core or said second side of said circular core;
wherein said chain comprising an endless loop and configured such that when said chain and said circular core are assembled together, said endless loop is generally taut around said circular core, wherein said pockets of said circular core are shaped in the shape of the drive link of said chain.

9. The circular saw blade assembly of claim 8, wherein said chain comprises a Bullet® Chain.

10. The circular saw blade assembly of chain 8 wherein said circular saw blade assembly is attached to a circular saw.

11. The circular saw blade assembly of chain 10 wherein said assembly is attached to a rescue saw.

12. The circular saw blade assembly of claim 8 wherein said pockets are in the shape of a drive link.

13. The circular saw blade assembly of claim 1 wherein said circular core is configured such that the pocket maintains contact with the leading edge and heel of the drive link and without placing pressure at the narrow tip at the bottom of the drive link.

14. A method of using a circular blade core in a circular saw, wherein said method comprises the following steps:
attaching a blade core comprising a circular disc like core body having an outer circumference and a width, wherein said core body comprises a central arbor substantially at the center of said disc and configured to provide an axis of rotation for a circular saw,
wherein said circular disc comprises a first side and a second side separated by said width of said circular disc, wherein said first side and said second side comprise a plurality of pockets projecting inward from said circumference toward said central arbor, wherein said pockets are spaced to fit a series of drive links of a saw chain, wherein said pockets comprise indentations that do not span the full width of said arbor, wherein said groves comprise alternating pockets such that said circumferences comprises alternating pockets on said first side and said second side;
attaching a chain comprising cutting elements to said blade core; and
using said saw to rotate said blade core and chain and cutting material with said cutting elements of said chain by contacting said rotating blade core and chain with said material.

15. The method of claim 14, wherein said saw is used to cut wood, metal, concrete and various hard materials.

16. The method of claim 15 wherein said saw is used in emergency rescue for cutting into a building, vehicle, train, cars or aircraft.

17. The method of claim 14 wherein said method further comprises the step of replacing said chain, wherein said chain is replaced by removing a rivet connecting two links of said chain, wherein said chain is removed from said circular core, wherein a second chain is attached to said core by placing consecutive drive links of said second chain having two ends into consecutive pockets of said circular core and attaching said two ends of said chain using a rivet to form an endless chain loop around said circular core.

18. The circular saw blade assembly of claim 1, wherein said circumference does not include sprocket teeth configured for the placement within link of a chain.

19. The method claim 14 wherein said blade core used in said method does not include sprocket teeth configured for the placement within link of a chain.
